(19) United States
(12) Patent Application Publication
(10) Pub. No.: US 2012/0253941 A1
(43) Pub. Date: Oct. 4, 2012

(54) Method And Apparatus For Distributing Content

(76) Inventor: Jeroen van Bemmel, The Hague (NL)

(21) Appl. No.: 13/074,595

(22) Filed: Mar. 29, 2011

(51) Int. Cl. G06Q 30/02

(52) U.S. Cl. 705/14.66

(57) ABSTRACT

A targeted content distribution capability via a broadcasting mechanism is disclosed herein. The targeted content distribution capability enables the combining of meta-data with broadcast information to form the broadcast signal. The capability also enables linking the meta-data to the advertised content. By broadcasting content “by reference” instead of by the actual advertised content, receiving devices may be configured to filter content distribution requests based on any suitable criteria. For example, filtering may be based on the receiver's supported capabilities and/or user preferences. Advantageously, a user may then retrieve advertised content targeted at the specific end user and tailored specifically to that end user's preferences and device.

### TECHNICAL FIELD

The invention relates generally to distributing content.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Content providers may deliver their content through, for example, “appStores” or online content stores such as: Apple iTunes, Amazon BookStore, and the like. Broadcasters deliver broadcast information such as, for example, FM and AM radio signals, digital radio signals, and Internet radio signals, to a heterogeneous installed based of devices such as, for example, iPhones, Android devices, eReaders, tablets, set top boxes, personal computers, and the like.

### SUMMARY

Various deficiencies are addressed by embodiments for providing targeted content distribution via a broadcasting mechanism. A targeted content distribution capability via a broadcasting mechanism is disclosed herein. The targeted content distribution capability enables the combining of meta-data with broadcast information to form the broadcast signal. The capability also enables linking the meta-data to the advertised content. By broadcasting content “by reference” instead of by value, receiving devices may be configured to filter content distribution requests based on any suitable criteria. For example, filtering may be based on the receiver's supported capabilities and/or user preferences. Advantageously, a user may then retrieve advertised content targeted at the specific end user and tailored specifically to that end user's preferences and device.

### BRIEF DESCRIPTION OF THE DRAWINGS

The teachings herein can be readily understood by considering the following detailed description in conjunction with the accompanying drawings, in which:

FIG. 1 depicts a high-level block diagram of an exemplary targeted content distribution system;

FIG. 2 depicts a block diagram of one embodiment of the exemplary broadcaster of FIG. 1;

FIG. 3 depicts a block diagram of one embodiment of the exemplary receiver of FIG. 1;

FIG. 4 depicts one embodiment for providing meta-data; and

FIG. 5 depicts one embodiment of a method for providing targeted content distribution.

To facilitate understanding, identical reference numerals have been used, where possible, to designate identical elements that are common to the figures.

### DETAILED DESCRIPTION OF THE INVENTION

As referred to herein, Meta-Data is any suitable information that describes the targeted content or that may be used in determining whether to advertise the availability of the targeted content on a receiving device. For example, Meta-Data may contain: (1) identity information such as seller information and/or application information; (2) device information such as targeted devices and/or applications; (3) capabilities information such as targeted functionality of the device and/or minimum software or hardware capabilities required by the Advertised Content; (4) profile information such as language; (5) location information such as country and/or area location which may be compared by the receiving device using, for example, GPS and/or stored data; (6) display control information such as translucency, size, location, images/text, and/or references to images/text; (7) network signal strength information; (8) environment information such as temperature; and (9) the like, as well as various combinations thereof.

A targeted content distribution capability via a broadcasting mechanism is disclosed herein. The targeted content distribution capability enables combining meta-data with broadcast content to form the broadcast signal and linking the meta-data to advertised content. By broadcasting content “by reference” (e.g., Meta-Data) instead of by value (e.g., the actual Advertised Content), receiving devices may be configured to filter content distribution requests based on any suitable criteria (e.g., the receiver's supported capabilities, user preferences and the like, as well as various combinations thereof) and also to retrieve advertised content targeted at the specific end user and tailored specifically to that end user's preferences and device.

It may be appreciated that targeted content distribution may also provide more efficient usage of resources. For example, only devices capable of using the content and end users wanting to consume the content, use the data network to retrieve it. Moreover, it may be appreciated that targeted content distribution may also reduce the amount of unwanted content being advertised.

It may be appreciated that end users may use targeted content distribution to get informed about interesting content for their device, to filter unwanted content distribution messages such as SPAM, and the like, as well as various combinations thereof. The service could be for free or for a fee.

It may be appreciated that device manufacturers may use targeted content distribution to differentiate their services, to distribute firmware or application updates, to automatically remove malware applications from a number of devices at one time and the like, as well as various combinations thereof.

It may be appreciated that advertisers and media agencies may use targeted content distribution to distribute applications, content used as part of advertising campaigns and the like, as well as various combinations thereof.

It may be appreciated that content providers such as, appStore, hosted content store and the like, may use targeted content distribution to advertise their applications, provide updates, advertise similar products to those purchased previously, and the like, as well as various combinations thereof.

In one embodiment, the targeted content distribution capability may include a broadcast interface configured to receive a broadcast signal containing meta-data. Moreover, a processor may be configured to retrieve the Meta-Data from the Broadcast Signal, retrieve Preference Information such as, from either local digital data storage and/or an external source such as a Preference Server, and to determine whether to display a selectable Advertised Content Indicator based on the Meta-Data and the Preference Information. Furthermore, a display may be configured for displaying and allowing selection of the selectable Advertised Content Indicator.

In another embodiment, the targeted content distribution capability may include a Content Source configured for outputting Broadcast Content and a Meta-Data Source configured for outputting Meta-Data. Moreover, a combiner may be configured for combining the Meta-Data with the Broadcast Content to form a Broadcast Signal. Furthermore, a receiver interface may be configured to transmit the Broadcast Signal.

In yet another embodiment, the targeted content distribution capability may include steps such as: receiving a Broadcast Signal, retrieve Meta-Data from the Broadcast Signal, retrieving Preference Information (e.g., from either local digital data storage, an external source such as a Preference Server and/or the like), determining whether to display a selectable Advertised Content Indicator based on the Meta-Data and Preference Information and to displaying the selectable Advertised Content Indicator.

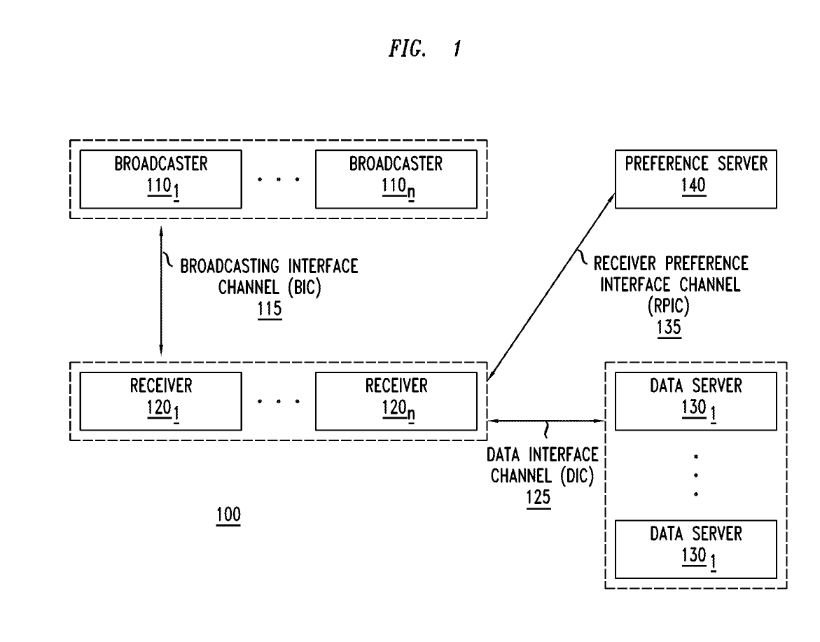

FIG. 1 depicts a high-level block diagram of an exemplary targeted content distribution system.

The targeted content distribution system 100 includes one or more Broadcasters 110₁-110_{N} (collectively, Broadcasters 110), one or more Receivers 120₁-120_{N} (collectively, Receivers 120), one or more Data Servers 130₁-130_{N} (collectively, DSs 130) and may include at least one Preference Server 140.

Broadcasters 110 broadcast a Broadcast Signal containing Broadcast Content, as defined herein, combined with Meta-data to Receivers 110. Receivers 110 retrieve the Meta-data information from the received Broadcast Signal and utilize the Meta-data information to determine whether to display an indicator on Receivers 120 for retrieving Advertised Content from one or more Data Servers 140.

Broadcasters 110 are configured for supporting a Broadcasting Interface Channel (illustratively, Broadcasting Interface Channel (BIC) 115 between Receivers 120). BIC 115 may support any suitable type(s) of broadcasting paths and protocols, such as, FM or AM radio audio signals, digital broadcasting (e.g., AAB or DVB), or networking technologies (e.g., WiFi, Bluetooth and Zigbee) and the like, as well as various combinations thereof. It will be appreciated that broadcasters may be any suitable apparatus that broadcasts over BIC such as, for example, FM and AM radio stations, digital radio stations, Internet radio stations, equipment providers, software/application providers, and the like).

Receivers 120 are configured for supporting a Broadcasting Interface Channel (illustratively, broadcasting interface channel (BIC) 115 between Broadcasters 110), and a Data Interface Channel (illustratively, Data Interface Channel (DIC) 125 between Data Servers 130).

Receivers 120 may be any suitable device incorporating a broadcasting interface channel, such as a mobile telephone, eReaders, tablets, set top boxes, personal computers, smart phones, handheld devices and the like.

Receivers 120 are configured for receiving a Broadcast Signal via BIC 115. It will be appreciated that, although depicted and described as supporting a single BIC 115, Receivers 120 are adapted for receiving Broadcast Signals from any suitable broadcast source (illustratively, any of the Broadcasters 110). Receivers 120 may be configured for receiving any suitable Broadcast Signal from any suitable broadcast source.

Receivers 120 are configured for receiving Data Communication Content via DIC 125. It will be appreciated that, although depicted and described as supporting a single DIC 125, Receivers 120 may be adapted for receiving Data Communication Content from any suitable data source (illustratively, any of the Data Servers 130). Receivers 120 may be configured for receiving any suitable Data Communication Content from any suitable data source.

Although depicted and described as supporting single data communication channels—DIC 125—, Receivers 120 are adapted for supporting any suitable number of channels supporting any suitable number(s) of sessions or any suitable number of IP flows.

Data Servers 130 are configured for supporting a Data Interface Channel (illustratively, Data Interface Channel (DIC) 125 between Receivers 120).

Data Servers 130 may be any suitable device providing Data Communication Content to Receivers 120. It may be appreciated that Data Communication Content may be any suitable data used by Receivers 120 to effectuate targeted content distribution. Examples include, Meta-Data, images, preferences and other data used to display a notification of available Advertised Content on Receivers 120, Advertised Content (e.g., the application, software or multimedia being downloaded), and the like, as well as various combinations thereof.

Preference Servers 140 are configured for supporting a Receiver Preference Interface Channel (illustratively, (RPIC) 135 between Receivers 120).

Preference Servers 140 may be any suitable device providing Preference Information to Receivers 120. It may be appreciated that Preference Information may be any suitable data used by Receivers 120 to effectuate targeting Receivers to display an indication of the availability of advertised content. For example, preferences may include: (1) whether the user of the Receiver: allows for targeted content distribution (e.g., on a per device basis or to block all user devices); (2) filters on time and place (e.g., (a user may block targeted content distribution on their office device during working hours or while in an office facility); (3) filters on advertised content providers (e.g., black lists and/or white lists of advertised content providers); (4) filters on types of advertised content (e.g., allowing advertised content by market segment such as business products, music or games, types of software/applications such as those owned by the user and types of devices such as those owned by the user); (5) parameters used to display the advertising content indicator, for example, (a) how the indicators may be displayed (e.g., limiting images to certain sizes, locations or areas on the display or transparency levels); and (b) when to display indicators (e.g., do not display an indicator that advertised content is available when other applications are in active use); and (6) the like, as well as various combinations thereof.

In one embodiment, Preference Server 140 may be configured to provide an interface to receive data over RPIC 135 or any other suitable channel to enable a user to manage preference data. It may be appreciated that these requests may be made from an end user using any suitable access method such as, for example, accessing a web page specified by a URL, using a specialized application, and the like as well as various combinations thereof. It may also be appreciated that requests received over RPIC 135 may be directed to any suitable management and/or monitoring activities such as: setting up filtering criteria (e.g., white list or black list filtering of sites; advertised content providers; and/or addresses); linking devices to a user or a group of users; setting up display criteria (e.g., Display Control Information); displaying reports (e.g., on received requests), and the like, as well as various combinations thereof.

It will be appreciated that DIC125 and RPIC 135 may support any suitable type(s) of communication paths and communication protocols. For example, DIC125 and RPIC 135 may support: wireless communications (e.g., GSM and CDMA); wireline communications; packet network communications (e.g., IP); VoIP communications (e.g., SIP); broadband communications (e.g., DSL); and the like, as well as various combinations thereof.

It may also be appreciated that DIC125 and RPIC 135 may support any suitable type(s) of encryption. It may be appreciated that many forms of encryption and authentication methods exist which may be utilized. Moreover, it may be appreciated that to protect the privacy of the stored information, access to varying degrees of sensitive end user information may use varying degrees of encryption and authentication methods.

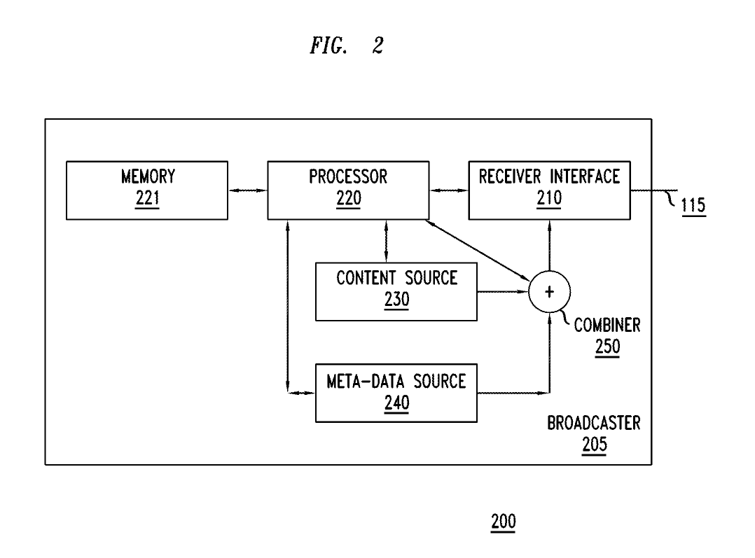

FIG. 2 depicts a block diagram of one embodiment of the exemplary broadcaster of FIG. 1.

Broadcaster 205 includes a Broadcast Interface 210, a processor 220, digital data storage 221, a Content Source 230, a Meta-Data Source 240, and a Combiner 250. It may be appreciated that although depicted in FIG. 2 as one system, the elements of Broadcaster 205 are not required to be co-located (e.g. Content Source 230, Meta-Data Source 240, and/or Combiner 250 may be located remotely). Moreover, it may be appreciated that the communication between elements of Broadcaster 205 need not be direct (e.g. buffers, switches, and other systems may lie between elements of Broadcaster 205). Furthermore, it may be appreciated that though depicted in FIG. 2 as singular elements, each of the elements of Broadcaster 205 may contain a plurality of such like elements cooperating to perform the functions described herein. Additionally, it may be appreciated that the Broadcaster 205 may be a distributed system that communicates through a communication network.

Receiver Interface 210 is configured for supporting communication with Receivers 120 via BIC 115. Processor 220 cooperates with Receiver Interface 210 for providing the various capabilities depicted and described herein (e.g. transmitting the broadcasting signal to Receivers 120).

The processor 220 is configured for controlling the operation of Broadcaster 205. The processor 220 is coupled to each of Receiver interface 210, digital data storage 221, and Combiner 230. Although depicted and described herein as being a single processor, it may be appreciated that in other embodiments, processor 220 may be a plurality of processors. For example, a separate processor may be coupled to broadcast interface 210 and/or a separate processor may control combiner 230. As such, the term processor referred to herein is meant to encompass all suitable combinations of processor(s) as described herein.

The digital data storage 221 is configured for storing programs, data, and like information suitable for use in providing various capabilities depicted and described herein. Processor 220 cooperates with digital data storage 221 for providing the various capabilities depicted and described herein. For example, processors may execute programs and control logic, access data for processing, process/combine Meta-Data and Broadcast Content, collect Meta-Data and Broadcast Content from sources and the like, as well as various combinations thereof.

Content Source 230 is configured for providing Broadcast Content. Processor 220 may cooperate with Content Source 230 for providing the various capabilities depicted and described herein (e.g., combining Meta-Data with Broadcast Content to create a Broadcast Signal for broadcast to Receivers 120). It will be appreciated that Broadcast Content may include any suitable content distributed to a group of interested users such as: audio (e.g., analog, digital or Internet radio); podcasts; video (e.g., movies, television programs, or sporting events); software/equipment updates (e.g., updates for a mobile device or application) and the like.

Meta-data Source 240 is configured for providing Meta-Data. Processor 220 may cooperate with Meta-data Source 240 for providing the various capabilities depicted and described herein (e.g., encoding Meta-Data with Broadcast Content to create a Broadcast Signal for broadcast to Receivers 120).

Meta-Data is not the actual Advertised Content and by broadcasting content “by reference” instead of by the actual Advertised Content, receiving devices may be configured to filter content distribution requests based on any suitable criteria. For example, receiving devices may filter content based on the receiver's supported capabilities and/or user preferences and as such, retrieve Advertised Content targeted at the specific end user and tailored specifically to that end user's preferences and/or device.

Combiner 250 is configured for combining Broadcast Content from any suitable Content Source 230 and Meta-Data received from any suitable Meta-Data Source 240. Processor 220 may cooperate with Combiner 250 for providing the various capabilities depicted and described herein (e.g., combining Meta-Data with Broadcast Content for broadcast to Receivers 120). It may be appreciated that Combiner 250 may be implemented as processor 220 in cooperation with digital data storage 221 without a separate Combiner component.

In one embodiment, Broadcaster 205 may be an FM radio station. Combiner 250 may encode Meta-data from Meta-data Source 240 into the FM signal from Content Source 230 using any suitable encoding technique. For example, Acoustic OFDM is a technique known in the art whereby an inaudible scrambling code is embedded in an audio signal. The inaudible scrambling code may be repeated over time intervals which may or may not be periodic. For example, Combiner 250 may replace a portion of the frequency spectrum of an original sound source provided by Content Source 230 with a shaped OFDM signal which contains Meta-Data from Meta-data Source 240. This combined signal may then be sent to Receiver Interface 210 for broadcast to Receivers 120 via BIC 115.

In another embodiment, broadcaster 205 may be an internet radio station. Input into Combiner 250 from Content Source 250 and Meta-data Source 240 may be any suitable representation of the data. For example, Content Source 230 may already be packetized or may be an original sound source signal. It will be appreciated that if an original sound source signal is inputted into Combiner 250, Combiner 250 will have to perform a packetizing function to enable a digital Internet radio stream. Combiner 250 may encode Meta-data from Meta-data Source 240 into packets from Content Source 230 using any suitable encoding or interleaving technique. For example, separate packets containing Broadcast Content and Meta-Data may be interleaved or Meta-Data information may be included in identifiable portions of a Broadcast Content packet. Alternatively, Meta-Data may be encoded in the input original sound source signal in a similar manner as described above for Acoustic OFDM and then packetized for output. The resultant signal from each of these methods may then be sent to Receiver Interface 210 for broadcast to Receivers 120 via BIC 115.

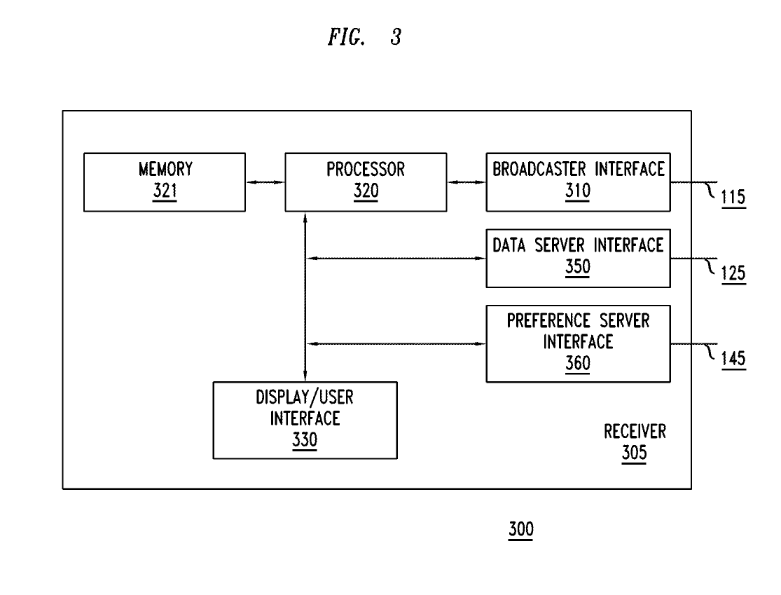

FIG. 3 depicts a block diagram of one embodiment of the exemplary receiver of FIG. 1.

Receiver 305 includes a Broadcast Interface 310, a processor 320, digital data storage 321, a Display/User Interface 330, a Data Server Interface 350, and a Preference Server Interface 360. It may be appreciated that the communication between elements of Receiver 305 need not be direct (e.g. buffers, switches, and other systems may lie between elements of Receiver 305). Furthermore, it may be appreciated that though depicted in FIG. 2 as singular elements, each of the elements of Receiver 305 may contain a plurality of such like elements cooperating to perform the functions described herein.

Broadcaster Interface 310 is configured for supporting communication with Broadcaster 205 via BIC 115. Processor 320 cooperates with Broadcaster Interface 310 for providing the various capabilities depicted and described herein (e.g. receiving the Broadcast Signal from Broadcaster 205).

The processor 320 is configured for controlling the operation of Receiver 305. The processor 320 is coupled to each of Broadcaster Interface 310, digital data storage 321, Display/User Interface 330, Data Server Interface 350 and Preference Server Interface 360. Although depicted and described herein as being a single processor, it may be appreciated that in other embodiments, processor 320 may be a plurality of processors (e.g. a separate processor may be coupled to Broadcaster Interface 310 Display/User Interface 330, Data Server Interface 350 and/or Preference Server Interface 360). As such, the term processor (e.g. processor 310) referred to herein is meant to encompass all suitable combinations of processor(s) as described herein.

The digital data storage 321 may be configured for storing programs, data, and like information suitable for use in providing various capabilities depicted and described herein. Processor 320 cooperates with digital data storage 321 for providing the various capabilities depicted and described herein (e.g., executing programs and control logic, accessing data for processing, processing Broadcast Signals from Broadcaster 205 to retrieve Meta-Data, transmitting Meta-Data to Data Server 130 and receiving content from Data Server 130 and the like, as well as various combinations thereof).

Display/User Interface 330 may be configured for displaying information and retrieving information from a user. Processor 320 may cooperate with Display/User Interface 330 for providing the various capabilities depicted and described herein, such as, displaying icons advertising available Advertised Content available for download or for collecting user input. Suitable methods may be used for retrieving or collecting information such as, for example: a display, a touch screen display, audio output, speech recognition capability, device buttons/keys, keyboard, pointer device (e.g., a mouse or touch pad), remote, virtual controller, and the like, as well as various combinations thereof.

It may be appreciated that Display Control Information may include any suitable information to control the display of the Advertised Content Indicator such as for example, translucency, size of the Advertised Content Indicator, display location or area, time or duration of display, and the like as well as various combinations thereof. It will also be appreciated that Preference Server 140 may contain and provide user preferences controlling predetermined values for Display Control Information, limits on Display Control Information, or Display Control Information defaults.

Data Server Interface 350 may be configured for interfacing with Data Server 130 via DIC 125 to enable retrieving any suitable data such as, for example, additional meta-data information needed to authenticate the targeted content for display, upon selection of the Advertised Content indicator by the user of Receiver 305, to retrieve the identified content and the like. Processor 320 may cooperate with Preference Server Interface 360 for providing the various capabilities depicted and described herein (e.g., retrieving additional meta-data information or delivering selected Advertised Content).

Preference Server Interface 360 may be configured for interfacing with Preference Server 140 via RPIC 135 to facilitate Receiver 305 targeting decisions. Processor 320 may cooperate with Preference Server Interface 360 for providing the various capabilities depicted and described herein, such as, retrieving preference data from Preference Server 140 to determine whether advertisements for Advertised Content should be displayed on Display/User Interface 330.

In one embodiment, Broadcaster Interface 310 receives a Broadcast Signal from Broadcaster 205 via BIC 115. Processor 320, running any suitable software client, in cooperation with digital data storage 321 may then probe the Broadcast Signal to determine whether the signal contains Meta-Data. If the Broadcast Signal contains Meta-Data, Processor 320 may then extract the Meta-Data from the Broadcast Signal. Processor 320 may then retrieve Preference Information from any suitable source such as, for example, locally stored preferences and device capabilities, Preference Server 140 and the like. Processor 320 may then process the Meta-Data in any suitable way to determine whether to display an indicator to the user regarding the availability of Advertised Content and how to display the indicator. For instance: (1) processor 320 may compare extracted Meta-data against locally stored preferences and device capabilities; (2) processor 320 may query Data Server 350 via DIC 125 to retrieve any suitable information such as, for example, using RDS magic strings extracted from the Meta-Data to retrieve additional Meta-Data which may be used in a comparison against retrieved Preference Information or to retrieve display information; (3) processor 320 may query Preference Server 140 via RPIC 135 to retrieve any suitable Preference Information such as, for example, filter preferences to be compared against received Meta-Data or display preferences to control when and how the Advertised Content Indicator is displayed on Display/User Interface 330. Processor 320 may then decide to display an Advertised Content Indicator on Display/User Interface 330 based on the filtering determination. If a user selects to receive the Advertised Content referenced by the displayed Advertised Content Indicator, Processor 320 may then direct Receiver 305 to retrieve the Advertised Content via DIC 125.

It may be appreciated that Preference Information may contain any suitable information used by processor 320 to compare and filter received Meta-Data to determine whether to display an Advertised Content Indicator and/or any suitable information used by processor 320 to determine when or how the Advertised Content Indicator will be displayed on Display/User Interface 330.

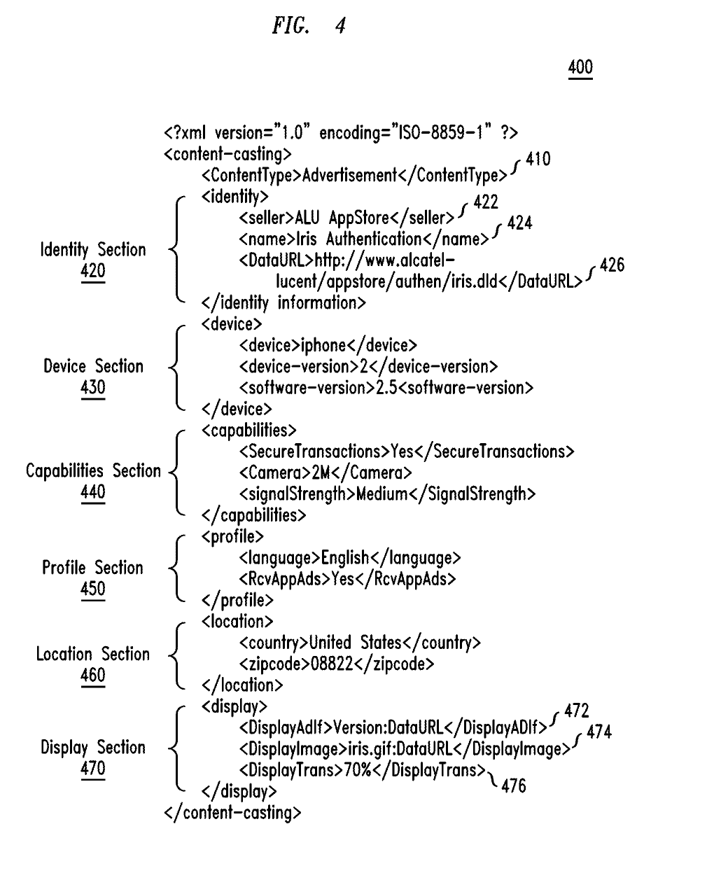

FIG. 4 depicts one embodiment for providing Meta-Data. As depicted in FIG. 4, Meta-Data may be in the form of an API customized by Broadcaster 205 based on the requirements of each of the individual Broadcasters 110 (e.g., providing a software update or an advertisement). It may be appreciated that by providing a flexible API, targeted content distribution may be achieved.

In one embodiment, the Meta-Data Directive 400 may include one or more of: fields and one or more such as, for example, ContentType 410 or one or more sections such as, for example, an identity Information Section 420, a Device Section 430, a Capabilities Section 440, a Profile Section 450, a Location Section 460 and a Display Section 470. Additionally, each section may also include one or more fields such as for example: a Seller Field 422, a Name Field 424, and a DataURL Field 426.

In one embodiment, fields may be used to indicate how Meta-Data is to be treated (i.e., a treatment field). For example, DisplayAdlf field 472 may indicate that an Advertised Content Indicator for a software upgrade will only be displayed if the user already has an application loaded and the version of the application is less than some predefined version.

In one embodiment, fields may point to a Data Server 130 which has more detailed information. For example, field DisplayImage 474 may point to images, such as icons, may be retrieved and displayed on Display/User Interface 330 of Receiver 305.

In one embodiment, fields may point to a how to display an Advertised Content Indicator. For example, field DisplayTrans 476 may point to the transparency level of the indicator to be displayed on Display/User Interface 330 of Receiver 305.

In another embodiment, fields may initiate an API interface to a Data Server 130 that returns either a result of some algorithm or additional information. For example, a target DisplayAdlf field 472 may prompt Receiver 305 to retrieve application information loaded on Receiver 305 (e.g., version information) and pass that information to Data Server 130 (e.g., via the URL defined in field DataURL 426). Data Server 130 may then determine whether an indicator of available Advertised Content, or an Advertised Content Indicator, should be displayed and return an icon or any suitable indicator to Receiver 305 related to the task to targeted content distribution.

In one embodiment, the Meta-Data Directive may include a randomized delay in either displaying the Advertising Content Indicator or retrieving selected Advertising Content to avoid overloading Data Servers 130. It will be appreciated that the delay interval may be broadcast by the servers based on any suitable characteristic such as audience size, Data Servers 130 capacity, network bandwidth constraints and the like.

It may be appreciated that any suitable way of delivering the directives and parameters of Meta-Data Directive 400 may be used, for example: all of the data may be delivered in separate forms; different sections may be defined; sections may co-exist in one region; sections or fields may be nested or configured in such as way as to indicate a relationship between sections or fields; treatment fields may be included in defined fields; or information on treatment of data may be pre-configured and stored in digital data storage.

Although primarily depicted and described with respect to XML and the fields shown in FIG. 4, it may be appreciated that any suitable formatting may be used to define the structure of the meta-data directive and that any suitable field or algorithm may be used within the meta-data directive. For example, instead of XML, an RDS magic string which provides information to fetch meta-data from Data Servers 130 over DIC 125 (e.g., a preconfigured URL over IP).

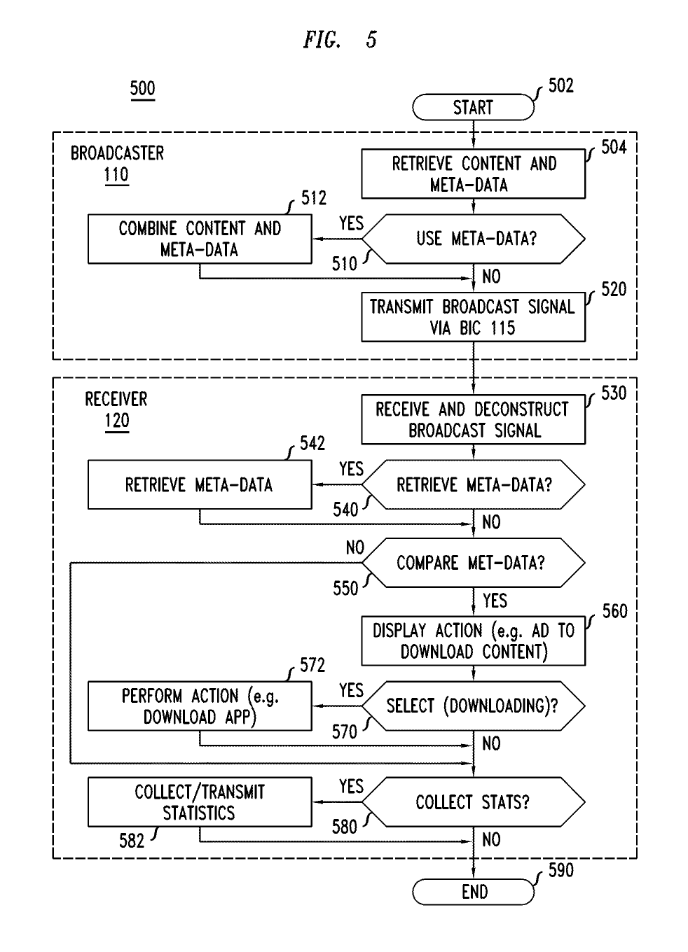

FIG. 5 depicts one embodiment of a method for providing targeted content distribution.

In one embodiment, a meta-data signature may be transmitted by Broadcaster 205 and received by Receiver 305 via BIC 115.

At step 502, method 500 begins. At step 504, processor 220 in cooperation with digital data storage 221 retrieves Broadcast Content from Content Source 230 and Meta-Data from Meta-data Source 240.

At steps 510 and 512, processor 220 in cooperation with digital data storage 221 may determine whether Receiver 305 should be targeted to receive Meta-Data (e.g., to receive an advertisement for the Advertised Content). It may be appreciated that Meta-data might be retrieved separately and in one embodiment, may only be retrieved after a determination has been made that meta-data will be combined to form the Broadcast Signal.

At step 520, processor 220 in cooperation with digital data storage 221 transmits the Broadcast Signal to Receiver 305 via BIC 115.

At step 530, processor 320 in cooperation with digital data storage 321 receives the Broadcast Signal from Broadcaster 205 via BIC 115, determines whether Meta-Data is contained in the Broadcast Signal, and if so, retrieves the Meta-data.

At steps 540 and 542, processor 320 in cooperation with digital data storage 321 determines whether Meta-Data needs to be retrieved from Data Servers 130 and if so, communicates with Data Servers 130 via DIC 125.

At step 550, processor 320 in cooperation with digital data storage 321 determines whether to display to the user information regarding the advertised Advertising Content on Display/User Interface 330.

At steps 570 and 572, processor 320 in cooperation with digital data storage 321 determines whether a user has selected the displayed Advertising Content indicator. It may be appreciated that processor 320 in cooperation with digital data storage 321 may display the Advertising Content Indicator for any suitable length of time. For example, processor 320 may terminate the display of the Advertising Content Indicator after some predetermined amount of time or until a predetermined event. It may be appreciated that meta-data may also indicate to processor 320 conditions for displaying the Advertising Content Indicator.

In one embodiment, the Advertising Content Indicator may be an icon linked to a download URL of the Advertising Content and which when selected initiates download of the Advertising Content to Receiver 305.

In one embodiment, at steps 580 and 582, processor 320 in cooperation with digital data storage 321 may determine whether to collect performance statistics. For example, how often and when Broadcast Signals contain Meta-Data, how often and when an indicator is displayed, the source of advertising requests (e.g., Advertised Content provider or broadcaster) and the like. It will be appreciated that any suitable statistics may then be stored locally in Receiver 305 or any performance metric suitable for compiling performance statistics may be transmitted to and collected in Preference Server 140.

Although primarily depicted and described in a particular sequence, it may be appreciated that the steps shown in method 500 may be performed in any suitable sequence. Moreover, the steps identified by one box may also be performed in more than one place in the sequence. For example, collecting statistics step 580 might be applied during and/or at the output of one or more of steps such as for example, steps 540, 570 and 580.

Although primarily depicted and described with respect to components in FIG. 1-3, it may be appreciated that any suitable components may be used to perform the steps of method 500 whether or not they are depicted and described in FIG. 1-3.

Although depicted and described herein with respect to embodiments in which, for example, programs and logic are stored within digital data storage and the digital data storage is communicatively connected to the processor, it may be appreciated that such information may be stored in any other suitable manner (e.g., using any suitable number of memorie(s), storage(s) or database(s)); using any suitable arrangement of memorie(s), storage(s) or database(s) communicatively coupled to any suitable arrangement of devices; storing information in any suitable combination of internal or external memory(s), storage(s) and/or database(s); or using any suitable number of accessible external memory(s), storage(s) and/or database(s). As such, the term digital data storage referred to herein is meant to encompass all suitable combinations of memory(s), storage(s), and database(s).

It is contemplated that some of the steps discussed herein as software methods may be implemented within hardware, for example, as circuitry that cooperates with the processor to perform various method steps. Portions of the functions/elements described herein may be implemented as a computer program product (e.g., Broadcaster 205 software may be created that is capable of cooperating with hardware to perform the functions as discussed herein), wherein computer instructions, when processed by a computer, adapt the operation of the computer such that the methods and/or techniques described herein are invoked or otherwise provided. Instructions for invoking the inventive methods or control of hardware/software components may be stored in fixed or removable media, transmitted via a data stream in a broadcast or other signal bearing medium, and/or stored within a digital data storage within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. An apparatus, comprising:
a processor and a digital data storage configured to:
retrieve meta-data from a broadcast signal;
retrieve user preference information; and
determine whether to display an advertised content indicator based on the meta-data and the user preference information; and
a user interface configured to display the advertised content indicator.

2. The apparatus of claim 1, wherein the broadcast signal further comprises an audio broadcast signal.

3. The apparatus of claim 2, wherein the meta-data is encoded in the audio broadcast signal using acoustic OFDM.

4. The apparatus of claim 1, wherein the meta-data comprises at least one of:
identity information;
device information;
capabilities information;
profile information;
location information;
display control information;
network signal strength information; and
environment information.

5. The apparatus of claim 4, wherein the display control information comprises an indicator to provide a randomized delay in at least one of displaying the advertised content indicator and retrieving selected advertised content.

6. The apparatus of claim 1, wherein retrieving user preference information comprises a preference server interface configured for retrieving the user preference information from a preference server.

7. The apparatus of claim 1, wherein the user preference information comprises at least one of:
an enable indicator indicating that the apparatus is enabled to display the advertised content indicator;
at least one time filter;
at least one location filter on location;
at least one advertised content providers filter;
at least one types of advertised content filter; and
at least one display parameter used to control display of the advertised content indicator.

8. The apparatus of claim 1, further comprising a data server interface configured for retrieving additional meta-data from a data server based on the meta-data, wherein the additional meta-data is used by the processor in determining whether to display the selectable advertised content indicator.

9. The apparatus of claim 1, wherein the processor further:
retrieves display control information for controlling display of the selectable advertised content indicator.

10. The apparatus of claim 9, wherein the display control information comprises at least one of:
time information for controlling a length of time the selectable advertised content indicator will be displayed;
size information for controlling a size of the selectable advertised content indicator;
location information for controlling a location of the selectable advertised content indicator;
image information for selecting an image to be used as the selectable advertised content indicator;
text information for selecting a text to be used as the selectable advertised content indicator;
translucency information for controlling a translucency of the selectable advertised content indicator; and
delay information for providing a randomized delay in displaying the selectable advertised content indicator.

11. The apparatus of claim 6, wherein the processor is further configured for:
transmitting performance metrics over the preference server interface.

12. An apparatus, comprising:
a content source configured for outputting broadcast content;
a meta-data source configured for outputting meta-data, the meta-data comprising a reference to advertised content;
a combiner configured for combining the meta-data with the broadcast content to form a broadcast signal; and
a receiver interface configured to transmit the broadcast signal.

13. The apparatus of claim 12, wherein the meta-data is encoded in the broadcast signal using acoustic OFDM.

14. The apparatus of claim 12, wherein the meta-data further comprises at least one of:
identity information;
device information;
capabilities information;
profile information;
location information;
display control information;
network signal strength information; and
environment information.

15. The apparatus of claim 14, wherein the display control information comprises an indicator for providing a randomized delay in either displaying an advertised content indicator or retrieving selected advertised content.

16. A method, the method comprising the steps of:
retrieving, by a processor in cooperation with a digital data storage, meta-data from a broadcast signal;
retrieving, by the processor in cooperation with the digital data storage, user preference information;
determining, by the processor in cooperation with the digital data storage, whether to display an advertised content indicator based on the meta-data and the preference information; and
displaying, on a user interface, the advertised content indicator.

17. The method of claim 16, wherein the user preference information comprises at least one of:
an enable indicator indicating that the apparatus is enabled to display the advertised content indicator;
at least one time filter;
at least one location filter;
at least one advertised content providers filter;
at least one types of advertised content filter; and
at least one display control parameter.

18. The method of claim 16, further comprising:
retrieving advertised content when the advertised content indicator is selected.

19. The method of claim 16, further comprising:
retrieving display control information, wherein the display control information controls how the selectable advertised content indicator will be displayed.

20. The method of claim 19, wherein the display control information comprises at least one of:
time information for controlling a length of time the selectable advertised content indicator will be displayed;
size information for controlling a size of the selectable advertised content indicator;
location information for controlling a location of the selectable advertised content indicator;
image information for selecting an image to be used as the selectable advertised content indicator;
text information for selecting a text to be used as the selectable advertised content indicator;
translucency information for controlling a translucency of the selectable advertised content indicator; and
delay information for providing a randomized delay in displaying the selectable advertised content indicator.
